(19) United States
(12) Patent Application Publication
(10) Pub. No.: US 2010/0230209 A1
(43) Pub. Date: Sep. 16, 2010

(54) QUICK DISCONNECT LADDER ASSEMBLY

(76) Inventors: Tim Hughes, Indian River, MI (US); Dennis Hughes, Ortonville, MI (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 12/722,796

(22) Filed: Mar. 12, 2010

Related U.S. Application Data
(60) Provisional application No. 61/210,038, filed on Mar. 16, 2009.

(51) Int. Cl. E06C 5/04; E06C 7/18; E06C 7/50

(52) U.S. Cl. 182/106; 182/127

(57) ABSTRACT

A quick connect/disconnect ladder assembly includes a mounting plate attached to a vehicle's tailgate of a truck bed, a pivot plate mounted thereto to which is attached a ladder on which to ascend to gain convenient access to the bed of the pickup truck. When the tailgate is opened, the ladder can be pivoted away from the vehicle bed to a substantially perpendicular position with respect to its original orientation against the tailgate of the truck. The ladder is then pivoted downwards such that the lower end of the rails or legs contact the ground surface. The ladder is further pivotable counterclockwise to its stowed position on the tailgate to disconnect the ladder and pivot plate from the mounting plate.

### CROSS-REFERENCES TO RELATED APPLICATIONS

This application claims the benefit of U.S. Provisional Patent Application Ser. No. 61/210,038 filed on Mar. 16, 2009 which is hereby incorporated by reference in its entirety.

### FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention generally relates to ladder assemblies for a vehicle's tailgate and more particularly to a quick-disconnect ladder assembly suited for use with a variety of vehicles such as flatbed trucks, sports utility vehicles, and pickup trucks.

2. Description of the Related Art

Because of the availability of options that make their ride as comfortable as many of the passenger vehicles as well as their functionality and convenience, pickup trucks today have become one of the most popular vehicles on the road not only for company or work vehicles but also as a family vehicle. In spite of its popularity as a family vehicle, the pickup truck still has some undesirable features. One such feature is that many users experience trouble accessing the bed portion of the truck. Because many are not tall enough to reach over the sides into the bed, they usually stand on the tire in order to access items that may be located in the bed. Access is possible by climbing over the sides into the truck bed but because of its height, such action often does not come without risk of injury. Because the vehicle bed is typically some distance from the ground surface, getting into and out of the vehicle bed for some can pose a severe injury problem. For example, jumping out of the vehicle bed can cause injury to feet, ankles, legs, as well as other parts of the human body should one fall on such attempt. Further, maintaining balance while climbing into or out of the bed portion may be difficult, especially for the elderly, weak, and the young.

To overcome these safety concerns, it has been proposed to use a ladder to get into or out of the vehicle bed. Most conventional ladders are unpractical because they are too large and take up significant storage space within the bed of the vehicle. Smaller ladders move around in the bed during travel and can easily be stolen if they are not secured to the vehicle. Unfortunately, most ladders whether large or small, do not have hand rails resulting in personal injury should a person lose balance and fall off the ladder. Ladders also require flat surfaces to stand on for proper stability. Such requirement would demand that the driver park the vehicle on a flat surface, which is generally inconvenient since many ground surfaces are inclined.

Because of these various considerations, the prior art is replete with prior art proposing solutions to various safety problems. For example, Peacock, U.S. Pat. No. 4,757,876, discloses a collapsible step ladder attached to the inside of a tailgate utilizing a pair of leveling braces that are positioned to hold a platform in a horizontal position when the step ladder is fully deployed. Unfortunately, the legs are not self-adjusting, and require bending down to adjust each leg separately. This is difficult to accomplish for a senior citizen or impaired individual. Further, the hinges connect the invention directly to the tailgate. Such connection increased the risk of structural failure, especially with lateral movements of the ladder, increasing the risk of damage to the tailgate as well as injury to a user.

Barksdale, U.S. Pat. No. 4,191,388, discloses a foldable ladder directly attached to the inside surface of a tailgate with an L-shaped bolt which is secured on one end by a nut. The problem with this tailgate ladder is that it does not come into contact with the ground and therefore it is subject to horizontal and vertical movement as the truck moves during use of the ladder. Again, as in Peacock above, this significantly increased the risk of injury to a user as stability is reduced during use. This is especially critical since Barksdale offers no handle that a user can use during ascending or descending the ladder.

Llewellyn, U.S. Pat. No. 4,848,821, discloses a foldable tailgate ladder attached to the outside panel of a tailgate. The ladder is attached to one side of the pickup truck where a cable attached to the tailgate and pickup body is provided with a handle to provide assistance in climbing on or off of the vehicle. Attaching the ladder to the outside panel of the tailgate reduces the aesthetics of the truck. Further, the connecting bolts are visible and may enhance corrosion to the outer panel painted surface. Further, connecting of bike racks or other auxiliary devices to the rear tailgate is no longer possible.

Several prior art patents disclose ladders which are slidable, pivotable, or telescopingly mounted with respect to the tailgate. In Burdette, U.S. Pat. No. 5,205,603, a tailgate ladder is disclosed which is arranged for the extension and retraction of a tailgate structure interiorly of a tailgate portion of the truck. Unfortunately, the handle is not integral to the invention and thus must be separately stored increasing the risk of loss.

Rolson, U.S. Pat. No. 6,003,633, discloses a detachable ladder for accessing the bed of a flatbed truck or trailer. The attachment bracket is fixedly attached to a rectangular metal post which is sized to fit into one of the stake pockets which are intended for receiving stakes or the like which extend the carrying capacity of the trailer. Rolson proposes that the pivotal connection between the ladder and the attachment bracket is made by two links so that the ladder can be positioned well outside the trailer frame while in use but can be pivoted upwardly and inwardly to permit the ladder to be stowed on the trailer bed without projecting outwardly beyond the trailer frame. The problem with Rolson's ladder is that if there is no room available on the trailer bed to pivot the ladder upwardly and inwardly to stow the ladder on the bed, the user must remove the post from the stake pocket and find another stake pocket to install the post such that the room is available on the bed of the truck to store the ladder after it is pivoted upward and inward to permit the ladder to be stowed on the bed without interfering with the load on the trailer or without projecting outwardly beyond the trailer frame.

Finally, Riggs, U.S. Pat. No. 7,080,713, discloses a ladder assembly that attached to the interior surface of the cargo space of a vehicle. A pivot armature attached to a mounting bracket by a pivot member with a yoke and adjustment guides at one end constitutes the mounting plate interconnecting the ladder to the pivot plate. The ladder is removable from the yoke by actuating the adjustment pins 168. However, it is not clear how the edge of the C-channel is removed from the raised protrusion to release the ladder from the mounting bracket. A further problem with Riggs is that if the ladder is stored within the cargo space while cargo such as rocks, sand, or dirt has been loaded, such cargo will be sufficiently high within the box to cover the adjustment guide mounted on the lowest leg or rail as well as the second joint, apertures of the adjustment guides and adjustment pins adapted to couple the yoke to the apertures. Without thoroughly cleaning out each one of these structural elements of the mounting plate it is conceivable that these elements become corroded and are unable to function properly in the long run.

Accordingly, the need for an improved ladder assembly that allows a user to exit and enter a vehicle bed in a safe and convenient way still exists. There also exists a need for a trailer bed ladder assembly that has some form of a handrail to assist a user while ascending or descending the ladder. Further it is desirable that the ladder be removable from the mounting bracket so that it is not exposed to typical cargo, i.e., sand, dirt, stone, cement, etc., carried in the cargo bed of a pickup truck and the ladder can be stored in any convenient stowage when not in use.

### SUMMARY OF THE INVENTION

The invention is directed to a ladder assembly for attachment to a flatbed of a truck or tailgate of a pickup truck. The assembly includes a mounting plate for attachment to the bed of a flatbed truck or the inside panel of a tailgate of a pickup truck. The ladder has a pair of side members and a plurality of rungs extending there between and a pivot plate mounted to the mounting plate to allow rotatable movement of the ladder from a storage position wherein the ladder is secured to the interior surface of the cargo space of the vehicle to a deployed configuration wherein the ladder is rotated and pivoted so as to be extended from the interior surface of the cargo space of the vehicle to the ground surface such that a user can safely access the cargo space of the vehicle by climbing the ladder.

In one embodiment, the present invention provides a ladder assembly for a pickup truck having a tailgate. The ladder assembly includes a mounting plate attached to the interior surface of the tailgate of the pickup truck, a ladder having two side members and a plurality of rungs extending therebetween, a pivot plate interconnecting the ladder to the mounting plate. The pivot plate retains the ladder in a storage configuration against the tailgate when the tailgate is in the closed position such that the side members of the ladder extend to the longitudinal width of the tailgate in the storage configuration and wherein the pivot plate permits the ladder to be rotated and then pivoted downwards to the ground in a deployed configuration.

Alternative to the storage configuration against the tailgate when the tailgate is in the closed position, the ladder and pivot plate may be rotated on the mounting plate so that the pivot plate disengages from the mounting plate and the ladder and pivot plate can be disconnected from the mounting plate and stored in a separate storage location on the vehicle to avoid exposure of the ladder to the cargo carried within the bed of the truck avoiding contaminating the ladder and pivot plate with sand, dirt, stones, etc., carried in the bed of the vehicle.

In a further embodiment of the invention, the ladder is provided with adjustable extensions which attach telescopingly to the side members to provide adjustment, in height, since the height of the tailgate to the ground can vary on different vehicles. The extensions are telescopingly adjustable for situations where the ground is uneven so that the ladder can be maintained substantially in a vertical plane to the tailgate.

A further feature of the invention is that a side member also houses a pivoting handle which is raised from a confined locked position within the envelope of one or the side members and pivoted to an upright locked position when the ladder is in a deployed position to provide a user a stable hand hold assist in ascending or descending the ladder.

It is the principal object of the present invention to provide an improved ladder mountable on the inner surface of a tailgate or end gate of a pickup truck to facilitate access to the truck bed.

It is a further object of the present invention to provide an improved ladder which stows flat against the inside surface of tailgate of a vehicle when not in use, and can be rotated and unfolded so as to suspend from the tailgate to provide steps to access the truck bed of the vehicle.

It is a further object of the invention to provide an improved ladder mountable on the inner surface of a tailgate of a vehicle with a mounting plate means wherein the attachment plate and ladder is conveniently disconnected from the tailgate to allow the ladder to be stored on the vehicle and not attached to the tailgate, thereby not exposing the ladder to the cargo, i.e., sand, dirt, cement, etc., that will be carried in the bed of the vehicle. If needed, the ladder can be re-attached to the tailgate to assist in accessing the cargo for unloading.

It is still a further object of the invention to provide a tailgate ladder that presents minimal interference to the loading and unloading of cargo from the vehicle.

Another object of the invention is to provide a tailgate that includes a handle assist for the elderly, weak, and young to provide support while ascending and descending the ladder.

Another object of the present invention is to provide a tailgate ladder which is simple, rugged, and requires only minimum time to stow or extend, as well as to remove and re-attach the ladder for use.

Other objects and advantages of the invention will be apparent from the following detailed description and appended claims.

### BRIEF DESCRIPTION OF THE DRAWINGS

FIG. 1 is a perspective view of the ladder assembly of one embodiment of the invention showing the ladder assembly attached to the tailgate of a vehicle;

FIG. 2 is a top view of the mounting plate attached to the tailgate of the vehicle with the ladder mounted to the pivot plate and the pivot plate attached to the mounting plate illustrating the stowage position on the tailgate after the tailgate is rotated to its open position;

FIG. 2A is a cross-sectional view taken along lines 2A-2A in FIG. 2;

FIG. 3 is a top view of only the mounting plate attached to the tailgate with mounting bolts as shown in FIG. 2;

FIG. 4 is a top view of only the pivot plate in the position as mounted to the mounting plate as shown in FIG. 2;

FIG. 5A is the top view of the pivot and mounting plates in position similar to FIG. 3 with the pivot plate rotated counterclockwise an additional 90° from the FIG. 3 position whereat the slots in the mounting plate become aligned with the tabs of the pivot plate such that the pivot plate is removable from the mounting plate;

FIG. 5B is a side view of the invention with the ladder in the deployed position to allow access to the bed of the vehicle;

FIG. 6 is a perspective view of one of the leg members illustrating a sliding U-channel member of rectangular configuration sliding within the U-shaped leg member to provide telescopic adjustment for the height of the ladder;

FIG. 7 is a plan view of the left leg member which illustrates the locked storage position of a pivotable handle which is deployed when the ladder is in use; and

FIG. 8 is a cutaway isometric view of the tailgate illustrating a second mounting bracket for the ladder while in a stowed configuration.

### DETAILED DESCRIPTION OF THE PREFERRED EMBODIMENT

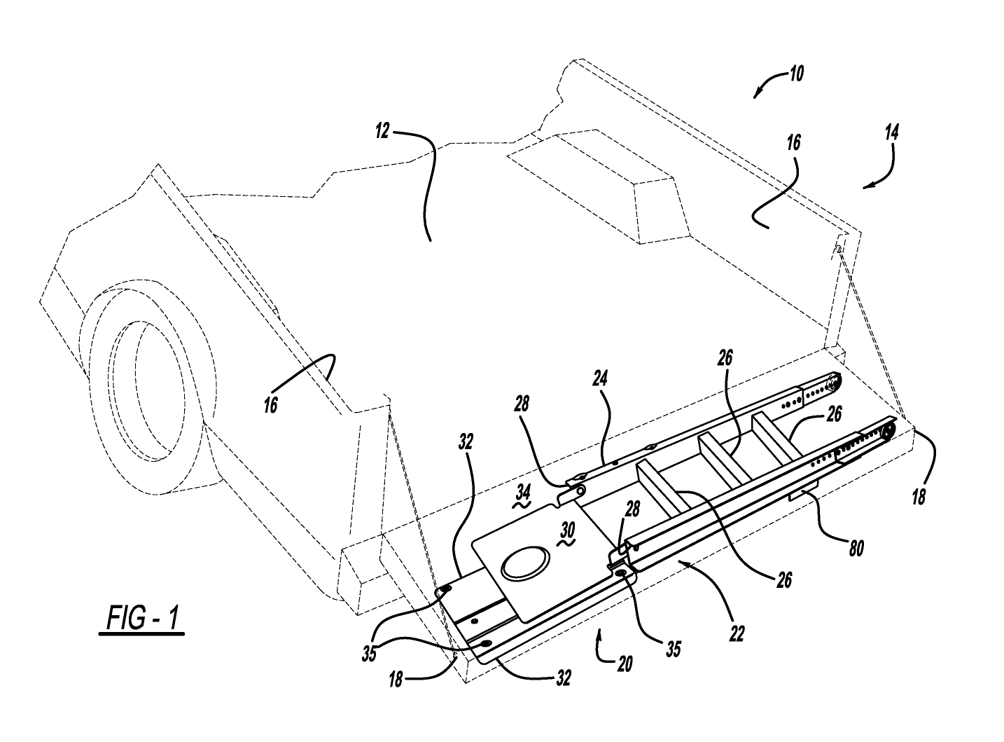

With reference to FIG. 1, there is illustrated in isometric view a ladder assembly configured in accordance with the preferred embodiment of the present invention. The ladder assembly is mounted to the tailgate of a pickup truck and adapted to assist a user in accessing the bed of the pickup truck. It is understood that the ladder assembly can be used with pickup trucks of different sizes as well as a variety of other vehicles, such as flatbed trucks, cargo trucks, sports utility vehicles, and the like.

As illustrated in FIG. 1, the pickup truck 10 includes a cab (not shown) at the front end thereof and a vehicle bed 12 at the rear end 14. The vehicle bed 12 is of conventional rectangular shape and includes upright sidewalls 16 extending rearwards from the cab (not shown) to the rear end 14 of the vehicle 10. The pickup truck 10 also includes a tailgate 18 extending between the upright sidewalls 16 of the truck 10. The tailgate 18 is pivotally attached to the vehicle bed 12 of the truck 10 to permit movement between an open and closed position.

As illustrated in FIG. 1, the ladder assembly 20 has a frame section 22 defined by parallel support legs or rails 24 with a plurality of rectangular steps 26 fixed between the parallel support legs 24. The upper end 28 of each of the parallel support legs 24 is pivotally connected to a pivot plate 30 which in turn, is rotatably mounted to a mounting plate 32 which rests on the inner panel 34 of the tailgate 18 and securely fastened thereto with self-tapping screws 35. The pivot plate 30 and mounting plate 32 configuration will be described in greater detail below.

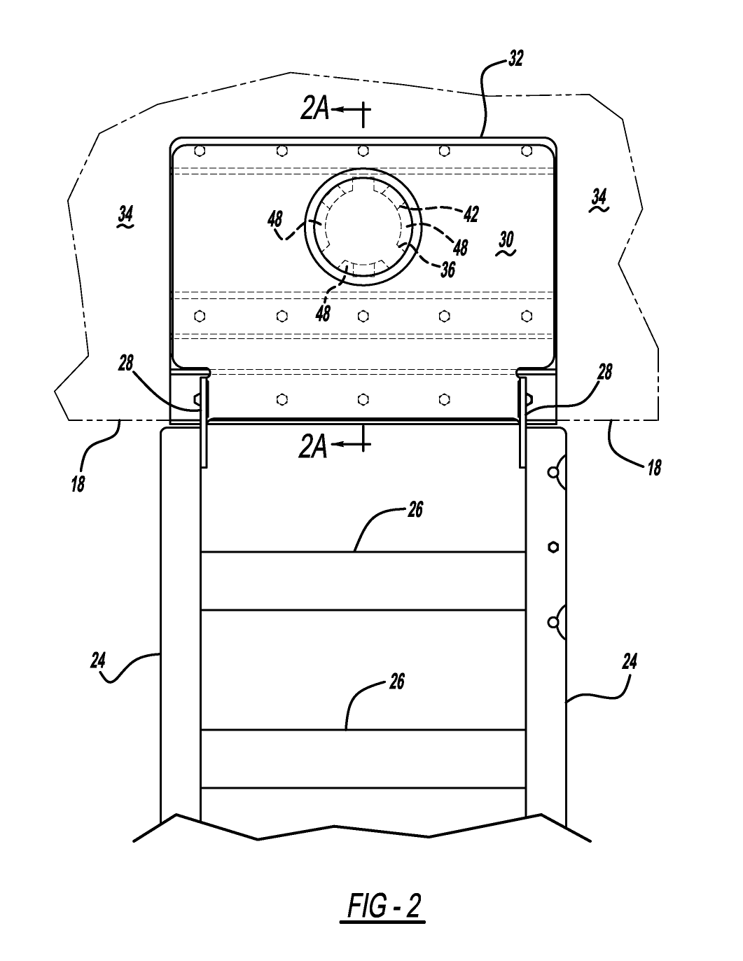

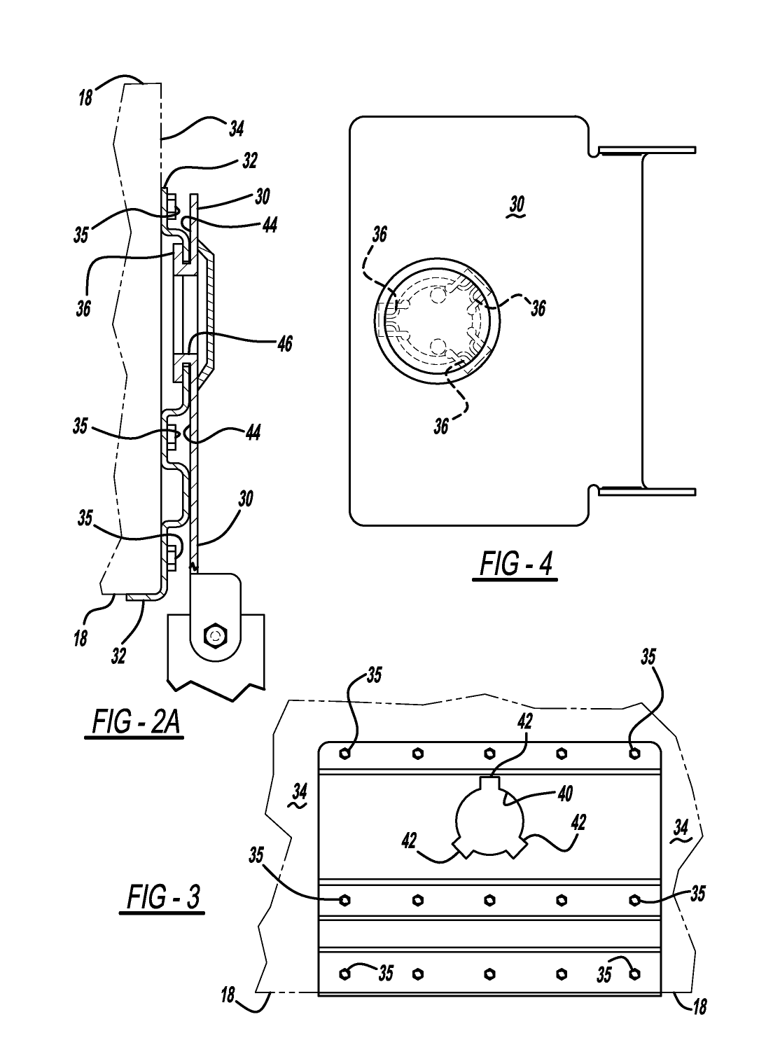

As illustrated in FIG. 2, the pivot plate 30 is mounted to the mounting plate 32 by interlocking a plurality of tabs 36 on the pivot plate 30 with a plurality of slots 42 in the mounting plate 32. With reference to FIGS. 2-6A, the interlocking arrangement will be discussed in detail. The mounting plate 32 is mounted directly to the inner panel 34 of the tailgate 18 by a series of self-tapping screws 35. Any combination of eight mounting holes can be used to secure the mounting plate 32 to the tailgate 18.

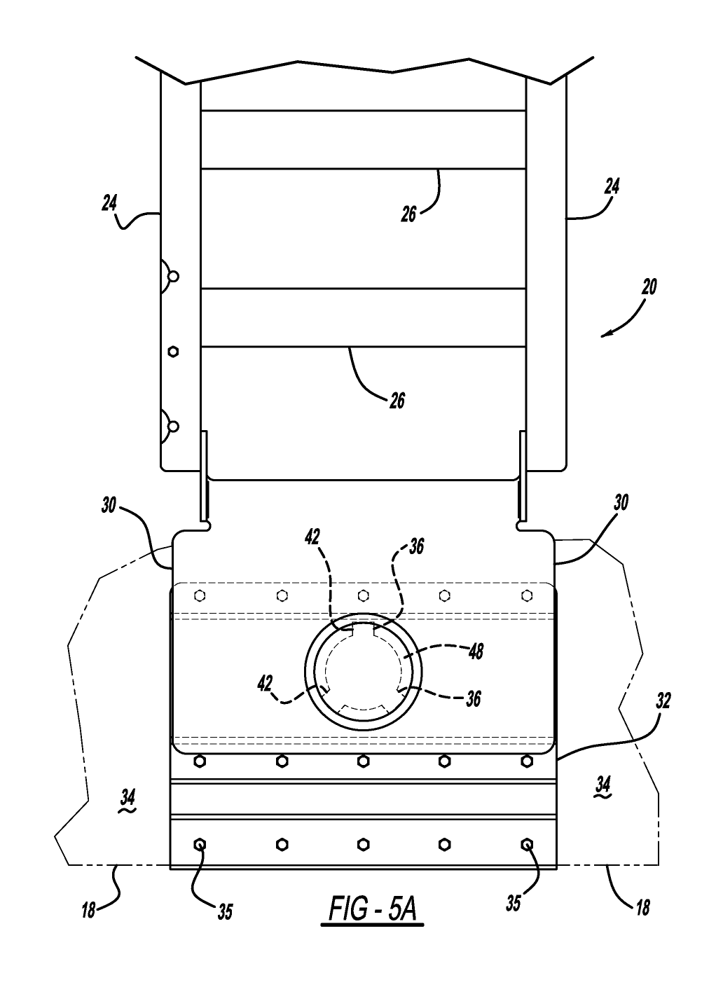

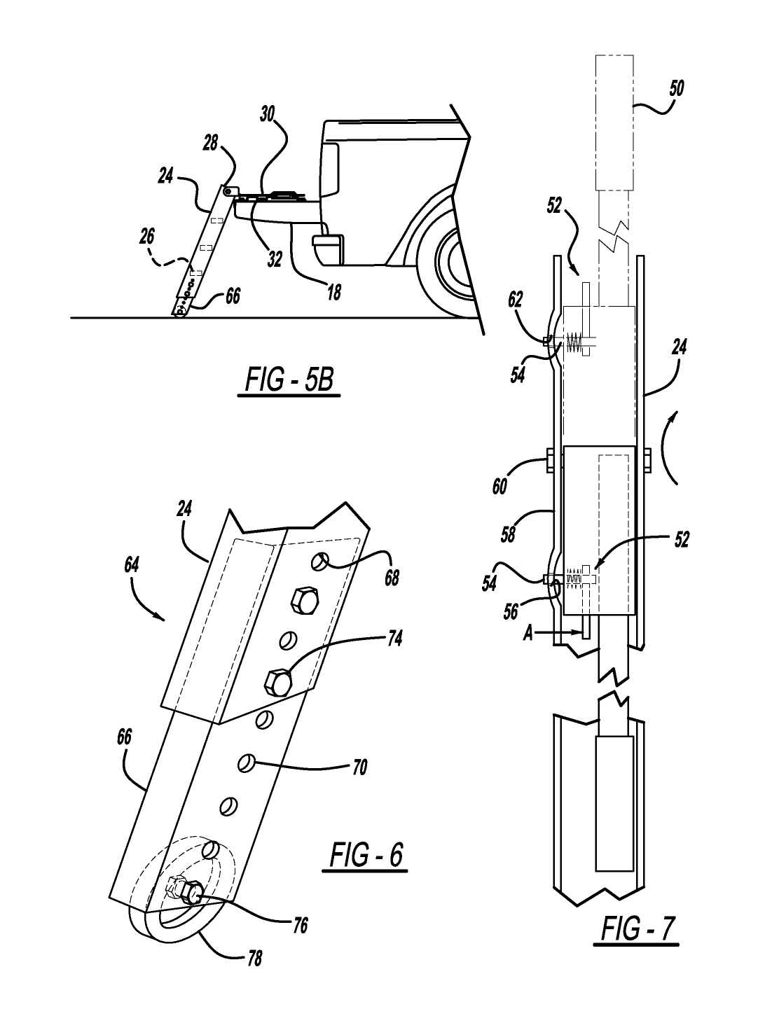

In a portion of the mounting plate 32 is located a cylindrical through-passage 40 with three peripherally angularly spaced slots 42 for receiving three offset tabs 36 located on the bottom 44 of the pivot plate 30. The offset tabs 36 are stamped in a depressed portion 46 made in the pivot plate 30. This depressed portion 46 or offset is cylindrical in form but may be configured in any form. The offset tabs 36 of the pivot plate 30 are circumferentially spaced to compliment the slots 42 in the mounting plate 32 such that when the pivot plate 30 is placed on the mounting plate 32 with the offset tabs 36 angularly aligned with the slots 42 in the mounting plate 32, the offset tabs 36 will drop into the slots 42 as shown in FIG. 5A and upon rotating the pivot plate 30 with respect to the mounting plate 32, the offset tabs 36 will interlock the pivot plate 30 to the mounting plate 32 by moving rotatably and interlocking with the material of the mounting plate 32 arcuately located 48 between the slots 42 as shown in FIG. 2. The angular location of the slots 42 and offset tabs 36 arrangement is by choice, depending on what position one wants the slots 42 to align with the offset tabs 36 to enable disconnecting the pivot plate 30 with the attached ladder assembly 20 from the mounting plate 32. In the preferred embodiment, two of the offset tabs were angularly spaced approximately 135° apart from the third offset tab. Again, any convenient spacing may be used to permit the disconnection of the pivot plate 32 from the mounting plate 30 at a convenient angular position.

FIGS. 5A-5B illustrate the quick disconnect feature of the present invention. As illustrated in FIG. 5A, when the pivot plate 30 is rotated counterclockwise from the stowed position shown in FIG. 1 such that the ladder assembly 20 is parallel to the longitudinal direction of the vehicle 10, the offset tabs 36 on the pivot plate 30 angularly align with the slots 42 in the mounting plate 32 to enable disconnecting the ladder assembly 20 and pivot plate 30 from the mounting plate 32, by lifting the pivot plate 30 straight up from the mounting plate 30 from the position shown in FIG. 5A. The ladder assembly 20 and pivot plate 30 are rotated 90° clockwise from the position shown in FIG. 5A to move the ladder assembly 20 into its stowed position lateral to the longitudinal direction of the vehicle 10. The ladder assembly 20 and pivot plate 30 in FIG. 5B have been rotated clockwise an additional 90° clockwise so as to be substantially perpendicular with respect to the tailgate 18 as well as pivoted downwards about the upper end 28 attachment points to allow the lower portion of the legs or rails 24 of the ladder assembly 20 to rest on the ground and permit the user to climb up the ladder assembly 20 and have access to the vehicle bed 12 of the pickup truck 10.

To assist the user in climbing the ladder assembly 20, FIG. 7 illustrates a plan view of a pivotable handle 50 which can be stored within the U-shaped channel of either right or left leg members 24. The pivotable handle 50 is deployed by retracting the spring loaded detent 52 to unlock (push in direction of arrow A) the pin 54 from the aperture 56 in the wall section 58 of the U-shaped channel of the leg member 24. Thereafter, the pivotable handle 50 is pivoted upwards about the attached pivot joint 60 until the spring loaded detent 52 is again moved into a second aperture 62 in the wall section 58 of the U-shaped channel and the pin 54 of the spring loaded detent 52 is locked into the aperture 62 to enable the pivotable handle 50 to assist a user in ascending or descending the ladder assembly 20 attached to the pivot plate 30.

Referring now to FIG. 6, there is shown a bottom portion 64 of the leg members 24 which is vertically telescoping via a sliding member 66 of the same cross-sectional configuration as the leg members 24 but smaller in size so as to slidingly nest within the U-shaped configuration of the leg members 24.

A series of aligned vertically spaced openings 68 are located in the web portion of the U-shaped leg member 24. A complementary series of holes 70 are made in the telescoping sliding member 66. Because tailgate heights may vary from vehicle to vehicle, the telescoping sliding member 66 can be adjusted when the ladder assembly 20 is initially installed on the vehicle 10. The initial adjustment is made permanent by two bolts and nuts 74 that are mounted in openings 68 in the U-shaped leg member 24 and holes 70 in the telescoping sliding member 66. The telescoping sliding member 66 can be adjusted by retracting or extending the telescoping sliding member an appropriate distance and thereafter engaging the bolts and nuts 74 with conveniently appropriate holes. Once the initial adjustment is completed, there should be no need for further adjustment since the distance from the tailgate 18 to the ground does not change on the same vehicle. A user, however, has the choice of further adjustment, if desired, to change the angle at which the ladder stands deployed with respect to the vehicle. 10

FIG. 6 also illustrates another embodiment of the invention wherein a roller member 78 is mounted to the bottom of the sliding telescoping member 66 to permit the ladder assembly 20 to move in a linear direction such as when a user ascends the ladder assembly 20 and the additional load of the weight of the user in the bed 12 of the vehicle 10 will cause the tailgate 18 to lower slightly due to the weight in the vehicle bed 12 acting on the springs of the vehicle 10. Rather than having the bottom portion 64 of the ladder assembly 20 be forced into the soil as the vehicle bed 12 receives a load or the tailgate 18 rises, if the ladder assembly 20 is on a concrete surface, the roller members 78 will move in a linear direction slightly and change the vertical inclination of the ladder assembly 20 to compensate for the movement of the bed 12 of the vehicle as it takes on a load in the bed 12. The roller members 78 are attached to a hole 70 of the sliding member by a bolt 76.

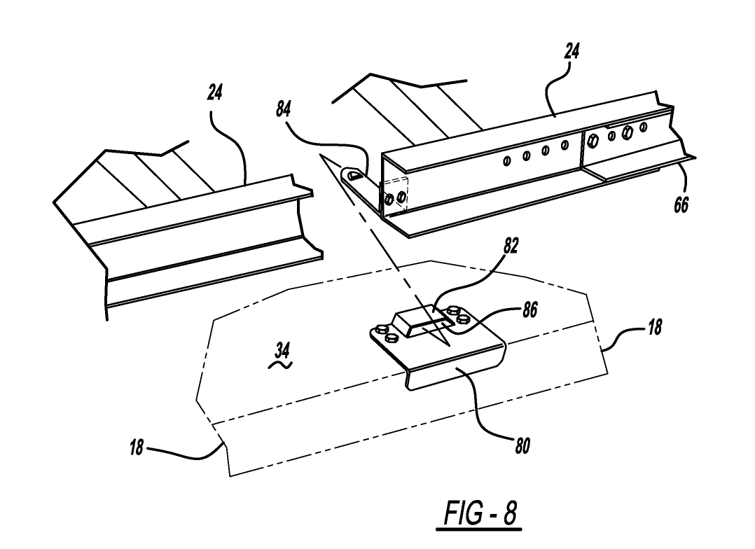

In FIG. 8 there is illustrated another feature of the invention. In order to secure the ladder assembly 20 in its stowed position, a latch pate 80 is mounted to the tailgate 18 near the bottom portion 64 of the leg members 24. The latch plate 80 has an offset portion 82 which extends towards the front of the vehicle 10. The offset portion 82 is adapted to receive a keeper finger 84 as the ladder assembly 20 is rotated into the stowed position from the deployed position. While the ladder assembly 20 is in the stowed position, the keeper finger 84 resides within the slot 86 made by the offset portion 82 so that the lower portion 64 of the ladder assembly 20 is secured to the tailgate 18 while in a stowed position.

Although the above-disclosed preferred embodiment of the present invention have shown, described, and illustrated the fundamental features of the present invention, it should be understood that various omissions, substitutions, and changes in the form of the details of the various elements, systems, and/or methods illustrated may be made by those skilled in the art without departing from the scope of the present teachings. Consequently, the scope of the invention should not be limited by the foregoing described preferred embodiment, but should be defined by the appended claims.

What is claimed is:

1. A quick disconnect ladder apparatus for a cargo vehicle having a cargo space adapted to receive cargo such as articles for transport, said quick disconnect ladder apparatus comprising:
a mounting plate;
means for mounting said mounting plate to the interior surface of said cargo space of said vehicle;
a pivot plate rotatably mounted to said mounting plate;
a ladder assembly attached to said pivot plate; and
means for pivoting said pivot plate from a first stowed position whereby said ladder assembly is stowed against said interior surface of said cargo space to a second deployed position whereby said ladder assembly is rotatable to a second deployed position to assist a user to ascend from the ground surface onto said cargo space or descend from said cargo space onto said ground surface, said pivoting means further pivoting said pivot plate to a third disconnect rotatable position whereby said pivot plate is detachable from said mounting plate and said ladder assembly and said pivot plate are removable from said cargo space.

2. The quick disconnect ladder apparatus as claimed in claim 1 wherein said mounting plate further comprises:
an aperture in said mounting plate, said aperture defining a plurality of peripheral slots circumferentially spaced about said aperture; and
a plurality of mounting holes spaced about said mounting plate such that said mounting plate may be secured to an interior surface of said cargo space of said vehicle.

3. The quick disconnect ladder apparatus as claimed in claim 1 wherein said ladder assembly further comprises:
a frame section comprising:
a pair of spaced support legs; and
a plurality of steps having one end attached to one of said pair of spaced support legs and an opposite end attached to the other of said pair of support legs; and
means for attaching said frame section to said pivot plate.

4. The quick disconnect ladder apparatus as claimed in claim 3 further comprising a handle assist means pivotally mounted to one of said pair of spaced support legs, said handle assist means comprising a handle pivotally mounted to one of said pair of spaced support legs such that said handle is pivotally movable from a stored locked position to a deployed upright locked position whereby a user while ascending or descending said ladder assembly may grasp and hold a handle to climb into or out of said cargo space of said vehicle.

5. The quick disconnect ladder apparatus as claimed in claim 3 further comprising a slidable adjustment member telescopingly attached to a bottom portion of each one of said pair of spaced support legs; and
means for adjustably attaching each of said slidable adjustment member to a complimentary spaced support leg.

6. The quick disconnect ladder apparatus as claimed in claim 3 further comprising means for moving each of said pair of spaced support legs when a load is placed in said cargo space.

7. The quick disconnect ladder apparatus as claimed in claim 2 wherein said means for pivoting said pivot plate from said first position to said second rotatable and third rotatable positions further comprises:
said pivot plate having a depressed offset portion defining a plurality of tab members offset from the lower surface of said pivot plate whereby when said depressed offset portion of said pivot plate and plurality of tabs thereon is aligned with said aperture and plurality of slots in said mounting plate at said third position, each of said plurality of tabs will align with a complementary slot of said plurality of slots and permit each said tab to enter each said complementary slot to interlock therewith upon rotation of said pivot plate from said third position to said first stowed position, and further whereby when said pivot plate is rotated further from said first stowed position to said second deployed position, said tabs remain interlocked with said slots such that said ladder may be pivoted downward with respect to said pivot plate to serve to provide access to said cargo area to a user.

8. The quick disconnect ladder apparatus as claimed in claim 2 wherein said ladder assembly further comprises:
a frame section comprising:
a pair of spaced support legs; and
a plurality of steps having one end attached to one of said pair of spaced support legs and an opposite end attached to the other of said pair of support legs; and
means for attaching said frame section to said pivot plate.

9. The quick disconnect ladder apparatus as claimed in claim 5 further comprising a handle assist means pivotally mounted to one of said pair of spaced support legs, said handle assist means comprising a handle pivotally mounted to one of said pair of spaced support legs such that said handle is pivotally movable from a stored locked position to a deployed upright locked position whereby a user while ascending or descending said ladder assembly may grasp and hold said handle to climb into or out of said cargo space of said vehicle.

10. The quick disconnect ladder apparatus as claimed in claim 4 further comprising a slidable adjustment member telescopingly attached to a bottom portion of each one of said pair of spaced support legs; and
means for adjustably attaching each of said slidable adjustment member to a complimentary spaced support leg.

11. The quick disconnect ladder apparatus as claimed in claim 4 further comprising means for moving each of said pair of spaced support legs when a load is placed in said cargo space.

12. The quick disconnect ladder apparatus as claimed in claim 8 wherein said means for pivoting said pivot plate from said first position to said second rotatable and third rotatable positions further comprises:
said pivot plate having a depressed offset portion defining a plurality of tab members offset from the lower surface of said pivot plate whereby when said depressed offset portion of said pivot plate and plurality of tabs thereon is aligned with said aperture and plurality of slots in said mounting plate at said third position, each of said plurality of tabs will align with a complementary slot of said plurality of slots and permit each said tab to enter each said complementary slot to interlock therewith upon rotation of said pivot plate from said third position to said first stowed position, and further whereby when said pivot plate is rotated further from said first stowed position to said second deployed position, said tabs remain interlocked with said slots such that said ladder may be pivoted downward with respect to said pivot plate to serve to provide access to said cargo area by a user.

13. A quick disconnect ladder apparatus for a cargo vehicle having a cargo space adapted to receive cargo such as articles for transport, said quick disconnect ladder apparatus comprising:
a mounting plate having:
an aperture defining a plurality of peripheral slots circumferentially spaced about said aperture; and
a plurality of mounting holes spaced about said mounting plate such that said mounting plate may be secured to an interior surface of said cargo space of said vehicle;
means for mounting said mounting plate to said interior surface of said cargo space of said vehicle;
a pivot plate rotatably mounted to said mounting plate;
a ladder assembly attached to said pivot plate, said ladder assembly further comprising:
a frame section having:
a pair of spaced apart legs; and
a plurality of steps having one end attached to one of said pair of spaced support legs and an opposite end attached to the other of said pair of spaced support legs; and
means for pivoting said pivot plate from a first stowed position whereby said ladder assembly is stowed against said interior surface of said cargo space to a second deployed position whereby said ladder assembly is rotatable to a second deployed position to assist a user to ascend from the ground surface onto said cargo space or descend from said cargo space onto said ground surface, said pivoting means further pivoting said pivot plate to a third disconnect rotatable position whereby said pivot plate is detachable from said mounting plate and said ladder assembly and said pivot plate are removable from said cargo space.

14. The quick disconnect ladder apparatus as claimed in claim 13 further comprising a handle assist means pivotally mounted to one of said pair of spaced support legs, said handle assist means comprising a handle pivotally mounted to one of said pair of spaced support legs such that said handle is pivotally movable from a stored locked position to a deployed upright locked position whereby a user while ascending or descending said ladder assembly may grasp and hold said handle to climb into or out of said cargo space of said vehicle.

15. The quick disconnect ladder apparatus as claimed in claim 13 further comprising a slidable adjustment member telescopingly attached to a bottom portion of each one of said pair of spaced support legs; and
means for adjustably attaching each of said slidable adjustment member to a complimentary spaced support leg.
